(19) United States
(12) Patent Application Publication
(10) Pub. No.: US 2002/0076568 A1
(43) Pub. Date: Jun. 20, 2002

(54) Cover part for a light source

(76) Inventors: Werner Reichert, Wuppertal (DE); Klaus Ganz, Wuppertal (DE)

Correspondence Address: Steven L. Oberholtzer, Brinks Hofer Gilson & Lione, P.O. Box 10396, Chicago, IL, 60610, US

(21) Appl. No.: 10/029,529

(22) Filed: Dec. 20, 2001

(30) Foreign Application Priority Data
Dec. 20, 2000 (DE) 200 21 657.0

(51) Int. Cl. B32B 15/04

(52) U.S. Cl. 428/469; 428/702; 428/704; 428/472.2; 428/336; 428/542.2

(57) ABSTRACT

The invention relates to a cover part for a light source, in particular for a headlight lamp in a motor vehicle headlight. The cover part has a wall with a first side facing the light source and having light-absorbing action. The wall also has a second side away from the light source, that has a reflective action. In order to achieve high light absorption, improved use characteristics under operating conditions which involved high thermal loads, and longer service life, combined with a production method involving a minimum possible capital outlay, the wall of a composite material having a metallic substrate, to which an optically active multilayer system is applied. The multilayer system is composed of a top layer, being a dielectric layer and preferably an oxide, fluoride or nitride layer of chemical composition MeO_{z}, MeF_{f}, MeNₛ with a refractive index n<1.8, a middle layer being a chromium oxide layer of chemical composition CrOₓ, and a bottom layer being of gold, silver, copper, chromium, aluminum, nickel and/or molybdenum. The indices x, z, r and s indicate a stoichiometric or non-stoichiometric ratio in the oxides, fluorides or nitrides.

### BACKGROUND OF THE INVENTION

The present invention relates to a cover part for a light source, in particular for a headlight lamp arranged in a motor vehicle headlight, having a wall, which has a first side, which faces the light source and has a light-absorbing action, and a second side, which preferably has a reflective action.

Cover parts of this type are generally known. They are intended, in particular in motor vehicle headlights, to cover part of the light emanating from a lamp which is secured in a reflector of the headlight. In many cases, the known cover parts have a screen-or shield-like design, in order to at least partially block the light beam which is emitted from the light source towards a transparent window which closes off the headlight, in particular the front side, so that the illuminating action of the headlight is determined primarily by the light which is thrown back by the reflector. The first side of the cover part, which has a light-absorbing action faces the light source, while the second side faces towards the window. As far as possible, the cover parts should not reflect the radiation which is blocked, and consequently, for this purpose, they are often concavely curved on the side facing the light source, where they are blackened, for example with the aid of paints, in order to achieve a strong light-absorbing action. The second side, on the side facing the window of the headlight, can then be of convex design and, in order not to let the cover part have a disturbing effect when looking at the headlight from the front, may also be provided with a surface which has a reflective action.

The light source used in motor vehicle headlights are generally lamps with a very high luminous intensity, such as halogen or xenon emitters, which also characteristically develop considerable heat. This results in the possible problem of decomposition of material in a provided blackening layer, which may, for example, lead to bleaching of the layer and/or to the evolution of gases from volatile constituents. The gases can in turn be deposited on, in particular, cooler parts of the headlamp, such as the reflector or the window, and also on the lamp itself. This entails an undesirable reduction in the power of the headlight or in a reduced service life of the light source.

### SUMMARY OF THE INVENTION

The present invention is based on the object of providing a cover part of the type described in the introduction which, firstly, leads to a high light absorption and, secondly, has improved use characteristics under operating conditions which in particular involve high thermal loads and has an improved service life. The above is achieved while using a production method that involves minimum possible capital outlays.

According to the invention, this is achieved by the fact that the wall consists of a composite material having a metallic substrate, to which, on a first side, an optically active multiplayer system composed of three layers is applied. The top layer of the multiplayer system is a dielectric layer, preferably an oxide, fluoride or nitride layer of chemical composition MeO_{z}, MeFᵣ, MeNₛ with a refractive index n<⅛. The middle layer of this multilayer system is a chromium oxide layer of chemical composition CrOₓ. The bottom layer of the multilayer system consists of gold, silver, copper, chromium, aluminum, nickel and/or molybdenum. Indices x, z, r and s indicate a stoichiometric or non-stoichiometric ratio in the oxides, fluorides or nitrides.

The top layer may alternatively be a silicon oxide layer of chemical composition SiO_{y}. The index y once again indicating a stoichiometric or non-stoichiometric ratio in the oxidic composition.

The optical multilayer system of the present invention can be applied, advantageously, without the need for salt solutions that are environmentally hazardous, and in some cases toxic, during production. For example, the metallic layer of optical multilayer system may be a sputtered layer or a layer which is produced by vaporization, in particular by electron bombardment or from thermal sources. The two upper layers of the optical multilayer system may likewise be sputtered layers, in particular layers produced by reactive sputtering, CVD or PECVD layers or layers which are produced by vaporization, in particular by electron bombardment or from thermal sources. As such, the overall optical multilayer system comprises layers which are applied in vacuum order, in particular in a continuous process.

In general, when radiation impinges on an object it is spit into a reflected fraction, an absorbed fraction and a transmitted fraction, which are determined by the reflectivity (reflectance), the absorptivity (absorptance) and the transmissivity (transmittance) of the object. Reflectance, absorptance and transmittance are optical properties which, depending on the wavelength of incident radiation (e.g. in the ultraviolet region, in the region of visible light, in the infrared region and in the region of thermal radiation) can adopt different values for the same material. Kirchhoff's law, according to which the absorptivity, in each case at a defined temperature and wavelength, has a constant ratio to the emittance, is known to apply to the absorptance. Therefore, Wien's displacement law and Planck's radiation law as well as the Stefan-Boltzmann law are of importance for the absorptance, describing defined relationships between radiation intensity, spectral distribution density, wavelength and temperature of the a black body. Calculations should take account of the fact that the black body per se does not exist, and real substances each deviate in a characteristic way from the ideal distribution. The optical multilayer system which is present according to the invention now makes it possible to selectively and controllably set the absorptivity and reflectivity, in particular in different wavelength regions.

According to the invention, it is in this way possible to set a total light reflectivity, determined in accordance with DIN 5036, part 3, on the side of the optical multilayer system at a preferred value of less than 5%; in addition to a height resistance to ageing, it is also possible to ensure a high thermal stability, in such a manner that, under a thermal load of 430° C./100 hours, the existing reflectivity changes only by less than 7%, preferably less than 4%. Moreover, under a thermal load of this type, there is advantageously no evolution of harmful gases.

As well as a high long-term thermal and chemical stability, the composite material which is present in accordance with the invention is also distinguished by good processability, in particular deformability, and a high thermal conductivity, on account of the metallic substrate, which may preferably by aluminum or steel. The latter is particularly important since it enables the heat which is take up by light absorption on the side which has a light-absorbing action and the heat which is taken up by the wall through the thermal radiation from the light source, to be dissipated rapidly.

The said processes for applying the layer system advantageously also enable the chemical composition MeO_{z}, MeF_{f}, MeNₛ of the top layer and the chemical composition CrOₓ, of the chromium oxide layer, with regard to the indices x, y, z, r and s, not only to be set at defined, discrete values but also allows a stoichiometric or non-stoichiometric ratio between the oxidized substance and the oxygen to be varied continuously within defined limits. In this way it is possible, for example, to specifically set the refractive index of the reflection-reducing top layer, which is also responsible for increasing the mechanical load-bearing capacity (DIN 58196, part 5) and the absorptivity of the chromium oxide layer, the absorptance decreasing as the value of the index x rises.

The composite material which, according to the invention, forms the wall, on account of its synergistically acting combination of properties

of the substrate layer, for example its excellent deformability, by means of which it withstands stresses produced in the production process of the cover part according to the invention during the shaping processes which are to be performed without problems, for example its high thermal conductivity and the capacity for a surface patterning which in the light wavelength region additionally promotes adsorption and is then followed by the other layers in relief, and moreover with a reflectance in the thermal radiation region which reinforces the action of the metallic layer of the optical three-layer system;

of the metallic layer which, on account of its constituents, which have a high reflectance and therefore a low emission in the thermal radiation region, takes account of the fact that, according to the Lambert-Bouguer law, the radiation power is absorbed exponentially as the penetration depth grows, and for most inorganic substances is available as thermal energy which can be passed on by substrate at even a very low depth (less than approximately 1 um);

of the chromium oxide layer, with its high selectivity of the absorptivity (peak values over 90% in the wavelength region from approximately 300 to 2500 nm, minimum values below 15% in the wavelength region>approx. 2500 nm) and its capacity for modification (index x) which has already been explained, and

of the top, in particular silicon oxide, layer, the advantages of which have to some extent already been pointed out above and which, in addition to its antireflective action, also has a high transmittance and, as a result, increases the proportion of the radiation values in the solar region which can be absorbed by the chromium oxide layer;

is eminently suitable for coating the material for production of the cover part according to the invention.

Furthermore, an intermediate layer may be provided on the substrate below the optical multilayer system, which intermediate layer firstly ensures mechanical and corrosion-inhibiting protection for the substrate and secondly ensures good adhesion for the optical multilayer system.

For the same purpose, a lower layer and/or, in particular with a view to increasing reflection, a decorative layer, such as a mirror coating, may be applied to the substrate on the side which is remote from the optical multilayer system.

Further advantageous embodiments of the invention are given in the subclaims and in the following detailed description.

### BRIEF DESCRIPTION OF THE DRAWINGS

The invention is explained in more detail on the basis of an exemplary embodiment illustrated by the appended drawing, in which:

FIG. 1 is a partial cross-sectional illustration through a wall of a cover part according to the invention; and

FIG. 2 is a partial cross-sectional illustration through a motor vehicle headlight having a cover part according to the invention.

### DETAILED DESCRIPTION OF THE INVENTION

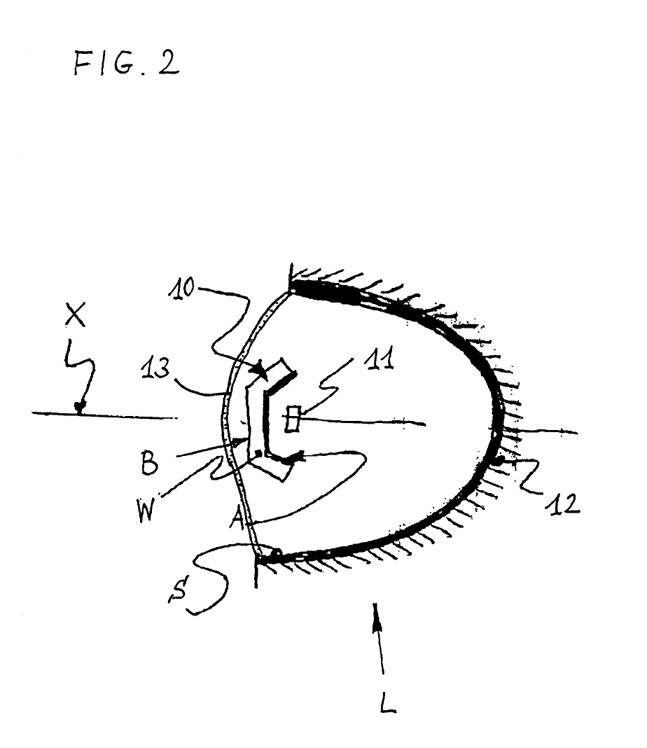

In the described embodiment of the invention, a wall W of a cover part (denoted by reference symbol 10 in FIG. 2) includes a composite material with a high selectivity of the absorptivity and reflectivity in the solar wavelength region and in the thermal radiation region.

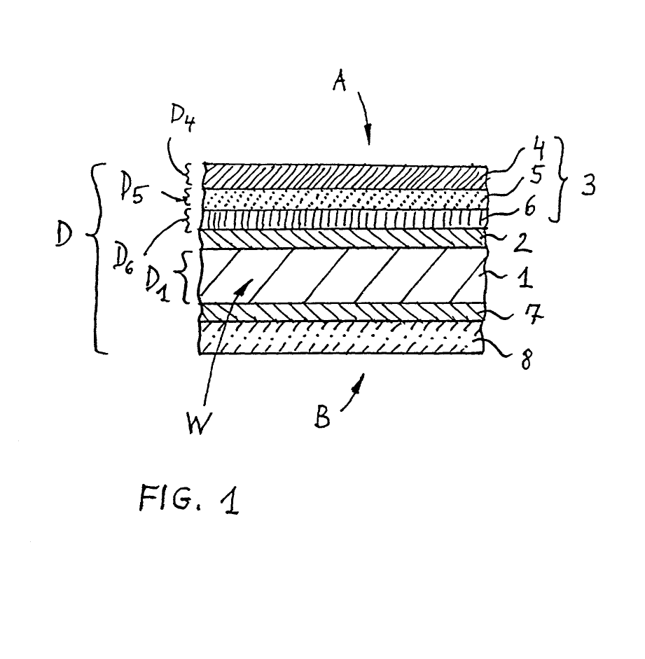

As shown in FIG. 1, the composite material comprises a strip-like substrate 1 of aluminum, which in particular is capable of undergoing deformation. An intermediate layer 2, is applied to the substrate 1 on a side A and an optically active multilayer system 2 is applied to the intermediate layer 2.

A total light reflectivity, determined in accordance with DIN 5036, part 3, on the side A of the optical multilayer system 3, is less than 5%.

The composite material may preferably be processed as a coil having a width of up to 1600 mm, preferably of 1250 mm, and a thickness D of approximately 0.1 to 1.5 mm, preferably of approximately 0.2 to 0.8 mm. The cover part 10 according to the invention can easily be produced from this coil as a stamped/embossed/bent part. The substrate 1 may preferably have a thickness D₁ of approximately 0.1 to 0.7 mm.

The aluminum of the substrate 1 may in particular be more than 99% pure, which promotes a high thermal conductivity.

The intermediate layer 2 consists of anodically oxidized or electrolytically brightened and anodically oxidized aluminum which is formed from the substrate material.

The multilayer system 3 comprises three individual layers 4, 5, and 6. The top and middle layers 4 and 5 are oxide layers and the bottom layer 6 is a metallic layer that is applied to the intermediate layer 2. The top layer 4 of the optical multilayer system 3 is in particular a silicon oxide layer of chemical composition SiO_{y}. The middle layer 5 is a chromium oxide layer of chemical composition CrOₓ, and the bottom layer 6 consists of gold, silver, copper, chromium, aluminum and/or molybdenum.

The indices x, y indicates a stoichiometric or non-stoichiometric ration of the oxidized substance to the oxygen in the oxides. The stoichiometric or non-stoichiometric ratio of the oxidized substance to the oxygen in the oxides. The stoichiometric or non-stoichiometric ration x may preferably lie in the range 0<x<3, while the stoichiometric or non-stoichiometric ratio y may adopt values in the range 1≦y≦2.

The fact that the top and middle layers 4, 5 of the optical multilayer system 3 may be sputtered layers, in particular layers produced by reactive sputtering, CVD of PECVD layers or layers produced by vaporization (in particular by electron bombardment or from thermal sources), means that it is possible to adjust the ratios x, y continuously (i.e. also to set them to non-stoichiometric values of the indices), with result that the layer properties can in each case be varied.

The top layer 4 of the optical multilayer system 3 may advantageously have a thickness D₄ of more than 3 nm. At this thickness D₄, the layer is already sufficiently efficient, yet the outlay on time, material and energy is low. An upper limit for the layer thickness D₄, in view of these aspects, is approximately 500 nm. An optimum value for the middle layer 5 of the optical multilayer system 3, in view of the abovementioned aspects, is a minimum thickness D₅ of more than 10 nm and a maximum thickness D₅ of approximately 1 um. The corresponding value for the bottom layer 6 is a thickness D₆ of at least 3 nm, at most approximately 500 nm.

With a view to achieving high efficiency, the bottom layer 6 of the optical multilayer system 3 should preferably be more than 99.5% pure. As has already been mentioned, the layer may be a sputtered layer or a layer which is produced by vaporization, in particular by electron bombardment or from thermal sources, so that the entire optical multilayer system 3 advantageously comprises layers 4, 5, 6 which are applied in vacuum order in a continuous process.

A lower layer 7, which—like the intermediate layer 2—may be an anodically oxidized or electrolytically brightened and anodically oxidized aluminum, is applied to that side B of the strip-like substrate 1 which is remote from the optical multilayer system 3. The intermediate layer 2 and the lower layer 7 may advantageously be produced simultaneously by wet-chemical means, in which case the pores in the aluminum oxide layer can be as far as possible closed off by hot compression during the final phase of the wet-chemical process sequence, resulting in a surface with long-term stability. Therefore, the lower layer 7—like the intermediate layer 2—offers mechanical and corrosion-inhibiting protection to the substrate 1.

A total light reflectivity, determined in accordance with DIN 5036, part 3, on the side B which is remote from the optical multilayer system 3, may preferably be at least 84%.

According to the invention, it is possible in particular to design the layer structure in such a manner that the total light reflectivity, determined in accordance with DIN 5036, part 3, on the side A of the optical multilayer system 3 and/or on the side B which is remote from the optical multilayer system 3, under a thermal load of 430° C./100 hours, undergoes changes of less than 7%, preferably of less than 4%.

FIG. 2 illustrates, as a typical application, the use of the cover part 10 according to the invention in a motor vehicle headlight L. As well as the cover part 10, a light source 11, a reflector hollow body 12 and a transparent window 13 that closes off the reflector hollow body 12 at the front of the headlight L, are diagrammatically illustrated in the drawing. The light source 11 is arranged along an optical axis X of the reflector hollow body 12 and is formed with a light-emitting surface, for example a tungsten lamp filament of a halogen lamp. The reflector hollow body 12 is curved concavely with respect to the light source and is provided with a light-reflecting (mirror-coated) surface S. Light that originates from the light source 1 and is reflected by the reflector 12 at the surface S and forms a light beam which emerges from the headlight L through the window 13.

The cover part 10 according to the invention prevents the occurrence of undesirable, so-called wandering, reflection in the headlight L. Its wall W, which is curved concavely with respect to the light source 11, surrounds the light source 11 in the manner of a screen, with its first, light-absorbing side A facing the light source 11. The other, convexly curved, preferably reflecting side B faces towards the window 13. The wall W of the cover part 10 is a composite material having the metallic substrate 1 and the multilayer system 3 (composed of three layers 4, 5, 6) as has been explained above. The cover part 10 according to the invention, which can be produced in an inexpensive, environmentally friendly manner, leads to high light absorption and heat dissipation, allowing relatively long service life of both the cover part 10 and the light source 11 to be ensured under the operating conditions in the closed reflector hollow body 12, which involve high thermal loads.

The present invention is not restricted to the exemplary embodiment illustrated, but rather comprises all means and measures which have a similar effect within the scope of the invention. For example, it is also possible for the bottom layer 6 of the optical multilayer system 3 to comprise a plurality of partial layers of gold, silver, copper, chromium, aluminum and/or molybdenum arranged above one another. As has already been mentioned, the top layer may alternatively also consist of fluorides or nitrides. Steel, in particular alloyed and/or surface-treated steel, is also an eminently suitable substrate material.

Furthermore, the person skilled in the art can supplement the invention with additional advantageous measures without departing from the scope of the invention. For example, it is possible—as is also illustrated in the drawing in FIG. 1—for a decorative layer 8 to be additionally applied to the side B, the side opposite of the optical multilayer system 3, and in particular to the lower layer 7. This decorative layer 8 may be, for example, a mirror coating which is metallic or consists of titanium nitride or other suitable materials which can be used to impart not only a gloss, but also a specific colour.

The range of applications for the cover part 10 according to the invention is not restricted to motor vehicle headlights, but rather also encompasses all other illumination devices which need a highly efficient light shield.

Furthermore, the invention is not restricted to the combination of features defined in claim 1, but rather may also be defined by any other desired combination of specific features of all the individual features disclosed. This means that in principle, virtually any individual feature of claim 1 can be omitted or replaced by at least one individual feature disclosed elsewhere in the application. In this respect, claim 1 is only to be understood as an initial attempt at putting an invention into words.

1. Cover part for a light source in a headlight lamp of a motor vehicle headlight, the cover part comprising a wall having first side and a second side, the first side facing the light source and having a light-absorbing action, which preferably has a reflective action, the wall being a composite material having a metallic substrate, an optically active multilayer system provided on the first side of the wall, the multilayer system being composed of three layers, a top layer of the multilayer system being a dielectric layer with a refractive index n<1.8, a middle layer of the multilayer system being chromium oxide layer of chemical composition CrOₓ, and a bottom layer of the multilayer system including at least one material selected from the group consisting of: gold, silver, copper, chromium, aluminum, nickel and molybdenum, whereby index x indicates a stoichiometric or non-stoichiometric ratio.

2. Cover part according to claim 1, wherein the top layer of the multilayer system is a silicon oxide layer of chemical composition SiO_{y}, the index y indicating a stoichiometric or non-stoichiometric ration.

3. Cover part according to claim 1, wherein the top layer is a chemical composition selected from the group consisting of MeO_{z}, MeFᵣ, or MeNₛ, whereby the indices z, r and s indicate a stoichiometric or non-stoichiometric ratio.

4. Cover part according to claim 1, wherein an intermediate layer is applied to the substrate between the multilayer system and the substrate.

5. Cover part according to claim 2, wherein a lower layer is applied to the substrate on a side of the substrate opposite of the side to which the multilayer system is applied.

6. Cover part according to claim 1, wherein the substrate is of aluminum.

7. Cover part according to claim 6, wherein the aluminum is more than 99.0% pure.

8. Cover part according to claim 4, wherein the intermediate layer is anodically oxidized aluminum.

9. Cover part according to claim 4, wherein the intermediate layer is electrolytically brightened and anodically oxidized aluminum.

10. Cover part according to claim 5, wherein the lower layer is anodically oxidized aluminum.

11. Cover part according to claim 5, wherein the lower layer is electrolytically brightened and anodically oxidized aluminum.

12. Cover part according to claim 1, wherein the substrate is of a material selected from the group consisting of steel, alloyed steel, surface-treated steel and alloyed and surface treated steel.

13. Cover part according to claim 1, wherein the stoichiometric or non-stoichiometric ratio x lies in the range 0<x<3.

14. Cover part according to claim 2, wherein the stoichiometric or non-stoichiometric ratio y lies in the range 1≦y≦2.

15. Cover part according to claim 1, wherein the bottom layer is a plurality of partial layers arranged above one another.

16. Cover part according to claim 15, wherein the partial layers are of a material selected from the group consisting of gold, silver, copper, chromium, aluminum, nickel and molybdenum.

17. Cover part according to claim 1, wherein at least one of the top and middle layers is a sputtered layer.

18. Cover part according to claim 17, wherein the sputtered layer is produced by reactive sputtering.

19. Cover part according to claim 1, wherein at least one of the top and middle layers are produced by vaporization.

20. Cover part according to claim 19, wherein the vaporization is by electron bombardment.

21. Cover part according to claim 19, wherein the vaporization is by thermal sources.

22. Cover part according to claim 1, wherein at least one of the top and middle layers is a CVD layer.

23. Cover part according to claim 1, wherein at least one of the top and middle layers is a PECVD layer.

24. Cover part according to claim 1, wherein the bottom layer is a sputtered layer.

25. Cover part according to claim 24, wherein the bottom layer is a sputtered layer provided by vaporization.

26. Cover part according to claim 25, wherein vaporization is by electron bombardment.

27. Cover part according to claim 25, wherein vaporization is from thermal sources.

28. Cover part according to claim 1, wherein layers of the multilayer system are applied in vacuum order in a continuous process.

29. Cover part according to claim 1, wherein the top layer has a thickness in the range of about 3 nm to about 500 nm.

30. Cover part according to claim 1, wherein the middle layer has a thickness in the range of about 10 nm to about 1 um.

31. Cover part according to claim 1, wherein the bottom layer has a thickness in the range of about 3 nm to about 500 nm.

32. Cover part according to claim 1, wherein the side of the wall having the multilayer system has a total light reflectivity of less than 5%.

33. Cover part according to claim 1, wherein a side of the wall opposite the side having the multilayer system has if a total light reflectivity of at least 84%.

34. Cover part according to claim 32, wherein the total light reflectivity, on the side of the wall having multilayer system, and/or on the side (B) which is remote from the optical multilayer system, under a thermal load of 430° C./100 hours, undergoes changes of less than about 7%.

35. Cover part according to claim 34, wherein the change is less than 4%.

36. Cover part according to claim 33, wherein the total light reflectivity on the side of the wall opposite the multilayer system, under a thermal load of 430° C./100 hours, undergoes changes of less than about 7%.

37. Cover part according to claim 36, wherein the change is less than about 4%.

38. Cover part according to claim 1, wherein the bottom layer of the multilayer system is of a material more than 99.5% pure.

39. Cover part according to claim 1, wherein the wall has a thickness in the range of about 0.1 to 1.5 mm.

40. Cover part according to claim 39, wherein the thickness is in the range of about 0.2 to 0.8 mm.

41. Cover part according to claim 40, wherein the cover part is a stamped part.

42. Cover part according to claim 40, wherein the cover part is an embossed part.

43. Cover part according to claim 40, wherein the cover part is a bent part.

44. Cover part according to claim 1, further comprising a decorative layer applied to the side of the substrate opposite the multilayer system.

45. Cover part according to claim 44, wherein the decorative layer is a mirror coating.

46. Cover part according to claim 5, further comprising a decorative layer applied to the lower layer.

47. Cover part according to claim 46, wherein the decorative layer is a mirror coating.
